(19) United States
(12) Patent Application Publication
(10) Pub. No.: US 2017/0356697 A1
(43) Pub. Date: Dec. 14, 2017

(54) FIN ELEMENT FOR A HEAT EXCHANGER

(71) Applicant: MAHLE International GmbH, Stuttgart (DE)

(72) Inventors: Falk VIEHRIG, Grafenau (DE); Johannes KAELBER, Muehlacker (DE); Elke DETTLING, Asperg (DE); Michael KOHL, Bietigheim Bissingen (DE); Karl Gerd KRUMBACH, Burgstetten (DE); Wolfgang SEEWALD, Tamm (DE)

(73) Assignee: MAHLE International GmbH, Stuttgart (DE)

(21) Appl. No.: 15/604,704

(22) Filed: May 25, 2017

(30) Foreign Application Priority Data
Jun. 8, 2016 (DE) 10 2016 210 159.5

(51) Int. Cl. F28F 3/02; B60H 1/22; H05B 3/14

(52) U.S. Cl. CPC F28F 3/027; H05B 3/146; B60H 1/2225; B60H 2001/2271; H05B 2203/02

(57) ABSTRACT

A fin element for a heat exchanger, in particular for a heating, ventilation, and/or air conditioning system of a motor vehicle, with a plurality of connecting sections and of longitudinal sections, whereby in each case two adjacent longitudinal sections are connected to one another by a connecting section, whereby at least one of the longitudinal sections has gills formed by webs and slots, whereby at least one of the webs has a flared web surface, whereby the web surface is flared out from the at least one longitudinal section, whereby the web surface forms at least two surface sections arranged angled to one another.

This nonprovisional application claims priority under 35 U.S.C. §119(a) to German Patent Application No. 10 2016 210 159.5, which was filed in Germany on Jun. 8, 2016, and which is herein incorporated by reference.

### BACKGROUND OF THE INVENTION

### Field of the Invention

The invention relates to a fin element for a heat exchanger, and a heat exchanger formed with a fin element of this kind.

### Description of the Background Art

DE 10 2009 021 179 A1 discloses a fin element for a heat exchanger, comprising a ribbed plate corrugated in a longitudinal direction and disposed between two structures, whereby a gaseous fluid can flow through the ribbed plate in a depth direction to transfer heat between the structures and the fluid and whereby a plurality of gills, arranged parallel one behind the other and extending transverse to the depth direction, with a gill depth and a gill angle relative to the depth direction are provided in the ribbed plate, whereby the gill angle is between 14° and 26°, whereby the gill depth is either in the range of 0.3 mm to 0.6 mm or in the range of 1.1 mm to 1.8 mm.

DE 10 2013 108 357 A1 discloses a lamellar element, having lamellae that are integrally connected to one another via connecting sections. To increase stiffness, the lamellar element is acted upon by its connecting sections approximately in the direction of the lamellae with a pressing force during manufacture, whereby at least the connecting sections are plastically deformed. In addition or alternatively, corrugations are introduced in some or all lamellae.

EP 2 125 404 B1 discloses an airflow heating device for a heating or air conditioning system of a vehicle, comprising a heating element, which is disposed in an airflow region and comprises an electrically conductive nonwoven fabric. EP 2 125 404 B1 discloses in addition an auxiliary heating device and a vehicle heating or air conditioning system, which comprises the airflow heating device.

EP 2 049 860 B1 discloses a corrugated fin with corrugation peaks or corrugation valleys and adjoining perpendicular or slightly inclined corrugation flanks having a bent edge, the corrugation flanks being arranged in each case between two flat tubes in a heat exchanger, whereby the corrugation flanks are provided with incisions formed out of their planes, whereby the bent edges are formed weakened such that the springback occurring during bending is reduced.

DE 10 2012 109 768 A1 discloses a radiator element for an air heater, a heating stage of an air heater of this kind, and a method for manufacturing a radiator element, in which a corrugated fin element is electrically contacted directly by screwing in of a contact element.

### SUMMARY OF THE INVENTION

It is therefore an object of the invention to provide a fin element for a heat exchanger, which enables good heat transfer at a low pressure drop and a simultaneously high stability. In addition, it is the object of the invention to provide a heat exchanger, which is improved with respect to good heat transfer at a low pressure drop and a simultaneously high stability.

An exemplary embodiment of the invention relates to a fin element for a heat exchanger, in particular for a heating, ventilation, and/or air conditioning system of a motor vehicle, with a plurality of connecting sections and longitudinal sections, whereby in each case two adjacent longitudinal sections are connected to one another by a connecting section, whereby at least one of the longitudinal sections has gills formed by webs and slots, whereby at least one of the webs has a flared web surface, whereby the web surface is flared out from the at least one longitudinal section, characterized in that the web surface forms at least two surface sections arranged angled to one another. Such a manner of execution enables an especially good heat transfer and in addition represents an exceptionally stable design form. The indicated design moreover combines in an optimal manner the necessary stability with as low a pressure loss as possible when the airflow to be heated flows through the heat exchanger. The gills in this case allow the distribution of partial airflows transverse to the flow direction of a main airflow and improve the heat transfer.

In an embodiment, a plurality of the webs or each web has a web surface which is flared out from the at least one longitudinal section and forms at least two surface sections arranged angled to one another.

Moreover, for example, a plurality or all of the longitudinal sections have flared web surfaces with at least two surface sections arranged angled to one another.

Advantageously, flow chambers are formed between the connecting sections and the longitudinal sections; said chambers can be flown through in a depth direction T in particular by air, whereby the surface sections, formed by the particular web surfaces, intersect the depth direction T at an angle β. The stability of the fin element is improved still further by this construction.

In addition, the webs may have a V-shaped, W-shaped, Z-shaped, hook-shaped, and/or I-shaped cross-sectional profile and/or web sections with a V-shaped, W-shaped, Z-shaped, hook-shaped, and/or I-shaped cross-sectional profile, whereby the webs with a V-shaped, W-shaped, Z-shaped, hook-shaped, and/or I-shaped cross-sectional profile and/or the web sections with a V-shaped, W-shaped, Z-shaped, hook-shaped, and/or I-shaped cross-sectional profile are flared out from a first side of the at least one connecting section and/or from a second side, opposite to the first side, of the at least one connecting section. As a result, the stability of the fin element is increased, in particular in the area of the gills. Moreover, the heat transfer and also the velocity profile of the air flowing through the gills are optimized.

Moreover, a number of webs, arranged adjacent to one another, can form at least one group, whereby the at least one group has an arrangement pattern, specific for the at least one group, comprising a series of webs each with a V-shaped, W-shaped, Z-shaped, hook-shaped, and/or I-shaped cross-sectional profile and/or web sections each with a V-shaped, W-shaped, Z-shaped, hook-shaped, and/or I-shaped cross-sectional profile.

A further manner of execution provides that the at least one connecting section has a plurality of groups, each of which has an arrangement pattern, specific for the particular group, comprising a series of webs each with a V-shaped, W-shaped, Z-shaped, hook-shaped, and/or I-shaped cross-sectional profile and/or web sections each with a V-shaped, W-shaped, Z-shaped, hook-shaped, and/or I-shaped cross-sectional profile. The heat exchange surfaces and also the connecting surfaces, available for connection to heat transfer elements, can be adapted to the particular requirement by means of these modes of execution.

In addition, the at least one connecting section can have at least one web surface group that repeats periodically along the at least one connecting section.

An embodiment provides that the at least one group of web surfaces has at least one mirror axis, arranged transverse to the depth direction T and substantially parallel to the web surfaces, such that the at least one group of web surfaces has at least two web surface sections made mirror-symmetric to one another. As a result, a high efficiency is achieved for a heat exchange network composed of heat transfer elements and fin elements.

An embodiment provides that the longitudinal sections and the connecting sections form a U-shaped, V-shaped, rectangular, trapezoidal, and/or Ω-shaped cross-sectional profile.

Moreover, the connecting sections can be connected materially, frictionally, and/or positively locking to heat exchange surfaces of the heat exchanger in such a way that the fin elements increase the heat transfer surfaces of the heat exchanger. This leads to an optimal heat conduction between the heat transfer elements and the fins of the fin element.

An exemplary embodiment of the heat exchanger provides that the heat exchanger has at least one fin element for a heat exchanger according to the description given above.

The heat exchanger can have at least two heat transfer elements, whereby a fin element formed according to the description given above is disposed between the two heat transfer elements.

The heat exchanger can be, for example, an electrical heating device. The use of the fin element of the invention is especially effective in such a device.

The electrical heating device advantageously has PTC heating elements, whereby the fin elements and the PTC heating elements are arranged adjacent to one another.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view of a fin element of the invention;

FIG. 2 shows a sectional view of a detail of a fin element according to FIG. 1;

FIG. 3 shows a perspective view of an exemplary embodiment of a fin element;

FIG. 4 shows a sectional view of a detail of a fin element according to FIG. 3;

FIG. 5 shows a perspective view of an exemplary embodiment of a fin element;

FIG. 6 shows a sectional view of a detail of a fin element according to FIG. 5;

FIG. 7 shows a perspective view of a detail of a fin element according to FIGS. 1 and 2;

FIG. 8 shows a perspective view of a detail of a fin element according to FIGS. 3 and 4;

FIG. 9 shows a perspective view of a detail of a fin element according to FIGS. 5 and 6;

FIG. 10 shows a sectional view of an embodiment of a detail of a fin element according to FIGS. 1 to 6;

FIG. 11 shows a sectional view of an embodiment of a detail of a fin element according to FIGS. 1 to 6;

FIG. 12 shows a sectional view of an embodiment of a detail of a fin element according to FIGS. 1 to 6;

FIG. 13 shows a sectional view of an embodiment of a detail of a fin element according to FIGS. 1 to 6;

FIG. 14 shows a sectional view of an embodiment of a detail of a fin element according to FIGS. 1 to 6;

FIG. 15 shows a sectional view of an embodiment of a detail of a fin element according to FIGS. 1 to 6;

FIG. 16 shows a sectional view of an embodiment of a detail of a fin element according to FIGS. 1 to 6;

FIG. 17 shows a sectional view of an embodiment of a detail of a fin element according to FIGS. 1 to 6;

FIG. 18 shows a sectional view of an embodiment of a detail of a fin element according to FIGS. 1 to 6;

FIG. 19 shows a sectional view of an embodiment of a detail of a fin element according to FIGS. 1 to 6;

FIG. 20 shows a sectional view of a detail of a fin element according to FIGS. 5, 6, and 9; and

FIG. 21 shows an illustration of the distribution of the air velocity in a detail of a fin element of the invention.

### DETAILED DESCRIPTION

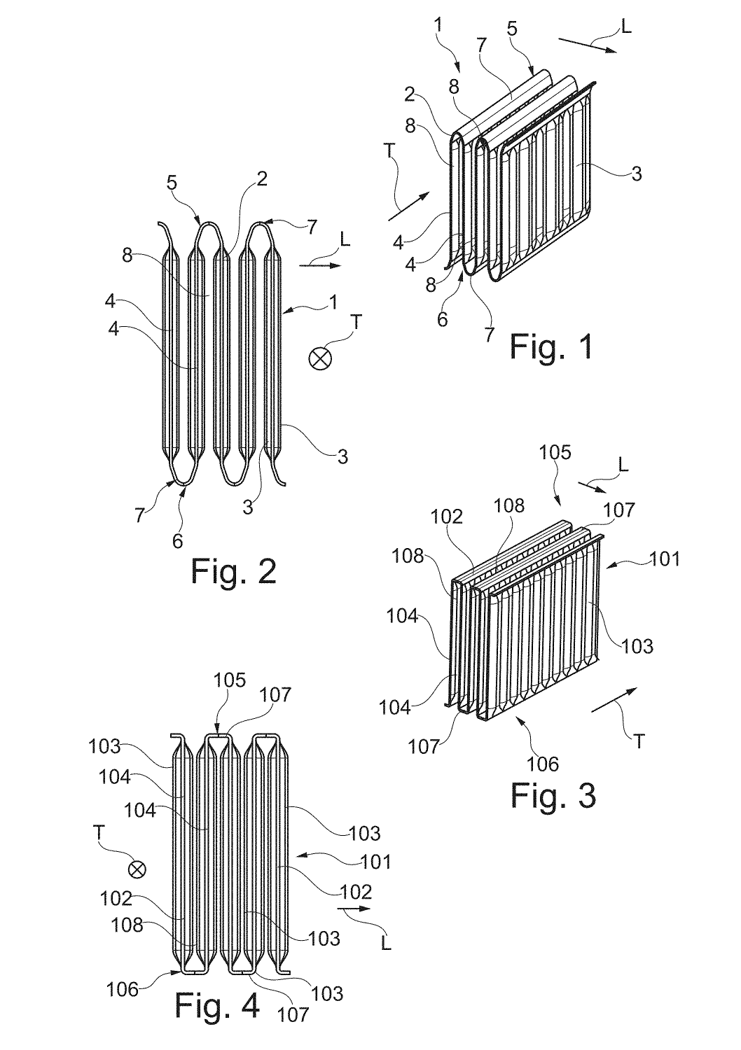

FIG. 1 shows an exemplary embodiment of a fin element 1 of the invention for a heat exchanger, which is not shown in greater detail. In this regard, FIG. 1 shows a representative detail of fin element 1, which can extend in any length in longitudinal direction L, depending on the particular requirements.

The heat exchanger can be, for example, a heating element for a motor vehicle. It can also be a coolant cooler or some other heat exchanger. Fin elements 1 in this case are disposed between heat transfer elements, which are not shown in FIG. 1 and which may be, for example, electrical heating elements or also tubes through which a heated coolant flows. Together with these heat transfer elements, a plurality of fin elements 1 form a heat exchanger block, which is normally used for heating an airflow. In this case, the airflow flows through the heat exchanger block in a depth direction T, which runs in the direction of a depth of the heat exchanger perpendicular to longitudinal direction L. The heat transfer elements, whose heat transfer surfaces are increased by means of fin elements 1, heat the airflow. This can then be used in particular for the energy-efficient heating of a vehicle cabin.

Fin element 1 in the exemplary embodiment shown in FIG. 1 is made as a corrugated fin with fins 2 and gills 3 of a continuous sheet corrugated in longitudinal direction L. Fins 2 and gills 3 in this case are made as one piece by a stamping, rolling, and/or folding method. In this case, fins 2 of fin element 1 have longitudinal sections 4 on which gills 3 are disposed. Longitudinal sections 4 of fins 2 of fin element 1 can have in each case a plurality of gills 3. Alternatively, some of longitudinal sections 4 can have no gills 3.

Fins 2 are arranged in rows in longitudinal direction L of fin element 1. In this case, fin element 1 has a first long side 5 and a second long side 6, opposite to first long side 5. Longitudinal sections 4 run from first long side 5 to second long side 6 or from second long side 6 to first long side 5. In the area of long sides 5, 6 of fin element 1, fins 2 have connecting sections 7, which connect together the two longitudinal sections 4 of a fin 2 and, moreover, form connecting surfaces for connecting fin element 1 to the heat transfer elements. Heat can be transferred via the connecting surfaces, formed by connecting sections 7, from heat transfer elements to fins 2 of fin element 1 and from there to the airflow.

Between their longitudinal sections 4 and connecting sections 7, fins 2 form flow chambers 8 through which the airflow flows, in particular in depth direction T. Moreover, partial airflows of the airflow flow through gills 3 out of flow chambers 8 into the particular adjacent flow chambers 8. The result is that, apart from the flow through flow chambers 8 in depth direction T, there is also a flow through flow chambers 8, said flow being substantially transverse to depth direction T. Flow chambers 8 in the exemplary embodiment shown in FIG. 1 are also bounded by connecting sections 7, apart from longitudinal sections 4. In this case, flow chambers 8, cut along longitudinal direction L of fin element 1, have a longitudinally extended cross-sectional profile, whereby connecting sections 7 are each formed U-shaped.

End longitudinal sections 4 of end fins 2 of fin element 1, which are not shown in FIG. 1, are connected in each case to another longitudinal section 4 via one of connecting sections 7 in the area of first long side 5 or second long side 6. The other longitudinal sections 4, not located at the ends, are connected via connecting sections 7 in each case to two other longitudinal sections 4 in the area of first long side 5 or second long side 6.

FIG. 2 shows a sectional view of fin element 1 shown in FIG. 1, whereby the cut is made in longitudinal direction L of fin element 1. Fin element 1 in longitudinal direction L of fin element 1 has fins 2 arranged in rows, whereby an airflow can flow through flow chambers 8, formed between longitudinal sections 4 and connecting sections 7, in depth direction T of fin element 1, said direction being perpendicular to longitudinal direction L.

Fin element 1 has a first long side 5 and a second long side 6 opposite to first long side 5. Longitudinal sections 4 of fins 2 are arranged running from first long side 5 to second long side 6 or from second long side 6 to first long side 5. Connecting sections 7 each connect two adjacent longitudinal sections 4 and are each disposed in the area of first long side 5 or second long side 6. Connecting sections 7 can be connected frictionally, positively locking, and/or materially to the heat transfer elements. Preferably gluing or soldering methods are used for this purpose. In the exemplary embodiment shown in FIG. 2, connecting sections 7 are formed curved in a U-shape such that they are concavely curved toward flow chambers 8 and convexly curved toward the heat transfer elements.

Longitudinal sections 4 have gills 3 which are arranged in rows along longitudinal sections 4. Exemplary embodiments of gills 3 will be described in greater detail in FIGS. 7 to 9.

FIG. 3 shows a further exemplary embodiment of fin element 101 of the invention for a heat exchanger. which is not shown in greater detail. In this regard, FIG. 3 shows a representative detail of fin element 101, which can extend in any length in longitudinal direction L, depending on the particular requirements.

The heat exchanger can be, for example, a heating element for a motor vehicle. Fin elements 101 in this case are disposed between the heat transfer elements, which are not shown in FIG. 3 and which may be, for example, electrical heating elements or also tubes through which a heated coolant flows. Together with these heat transfer elements, a plurality of fin elements 101 form a heat exchanger block, which is normally used for heating an airflow. In this case, the airflow flows through the heat exchanger block in a depth direction T, which runs in the direction of a depth of the heat exchanger block perpendicular to longitudinal direction L. The heat transfer elements, whose heat transfer surfaces are increased by means of fin elements 101, heat the airflow. This can then be used in particular for the energy-efficient heating of a vehicle cabin.

Fin element 101 in the exemplary embodiment shown in FIG. 3 is made as a corrugated fin with fins 102 and gills 103 of a continuous sheet corrugated in longitudinal direction L. Fins 102 and gills 103 in this case are made as one piece by a stamping, rolling, and/or folding method. In this case, fins 102 of fin element 101 have longitudinal sections 104 on which gills 103 are disposed. Longitudinal sections 104 of fins 102 can have in each case a plurality of gills 103. Alternatively, some of longitudinal sections 104 can also have no gills 103.

Fins 102 are arranged in rows in longitudinal direction L of fin element 101. In this case, fin element 102 has a first long side 105 and a second long side 106, opposite to first long side 105. Longitudinal sections 104 run from first long side 105 to second long side 106 or from second long side 106 to first long side 105. In the area of long sides 105, 106, fins 102 of fin element 101 have connecting sections 107, which in each case connect together the two longitudinal sections 104 of a fin 102 and, moreover, form connecting surfaces for connecting fins 102 of fin element 101 to the heat transfer elements. Heat can be transferred via the connecting surfaces, formed by connecting sections 107, from heat transfer elements to longitudinal sections 104 of fins 102 and from these to the airflow. Connecting sections 107 in the exemplary embodiment shown in FIG. 3 are arranged substantially perpendicular to longitudinal sections 104.

Between their longitudinal sections 104 and connecting sections 107, fins 102 of fin element 101 form flow chambers 108 through which the airflow can flow, in particular in depth direction T. Moreover, partial airflows of the airflow flow through gills 103 out of flow chambers 108 into the particular adjacent flow chambers 108. The result is that, apart from the flow through flow chambers 108 in depth direction T, there is also a flow by the partial airflows through flow chambers 108, said flow being substantially transverse to depth direction T. Flow chambers 108 in the exemplary embodiment shown in FIG. 3 are also bounded by connecting sections 107, apart from longitudinal sections 104. In this regard, flow chambers 108, cut along longitudinal direction L of fin element 101, have a longitudinally extended rectangular cross-sectional profile.

FIG. 4 shows a sectional view of fin element 101 shown in FIG. 3, whereby the cut is made in longitudinal direction L of fin element 101. Fin element 101 in longitudinal direction L of fin element 101 has fins 102 arranged in rows, whereby an airflow can flow through flow chambers 108, formed between longitudinal sections 104 and connecting sections 107 of fins 102 of fin element 101, in depth direction T of fin element 101, said direction being perpendicular to longitudinal direction L.

Fin element 101 has a first long side 105 and a second long side 106 opposite to first long side 105. Longitudinal sections 104 of fins 102 are arranged running from first long side 105 to second long side 106 or from second long side 106 to first long side 105. Connecting sections 107 each connect two adjacent longitudinal sections 104 and are each disposed in the area of first long side 105 or second long side 106. Connecting sections 107 can be connected frictionally, positively locking, and/or materially to the heat transfer elements. Preferably gluing or soldering methods are used for this purpose. In the exemplary embodiment shown in FIG. 4, connecting sections 107 are arranged perpendicular to longitudinal sections 104 in such a way that they form a relatively large connecting surface for connecting fin element 101 to the heat transfer elements. Longitudinal sections 104 have gills 103 which are arranged in rows along longitudinal sections 104. Exemplary embodiments of gills 103 will be described in greater detail in FIGS. 7 to 9.

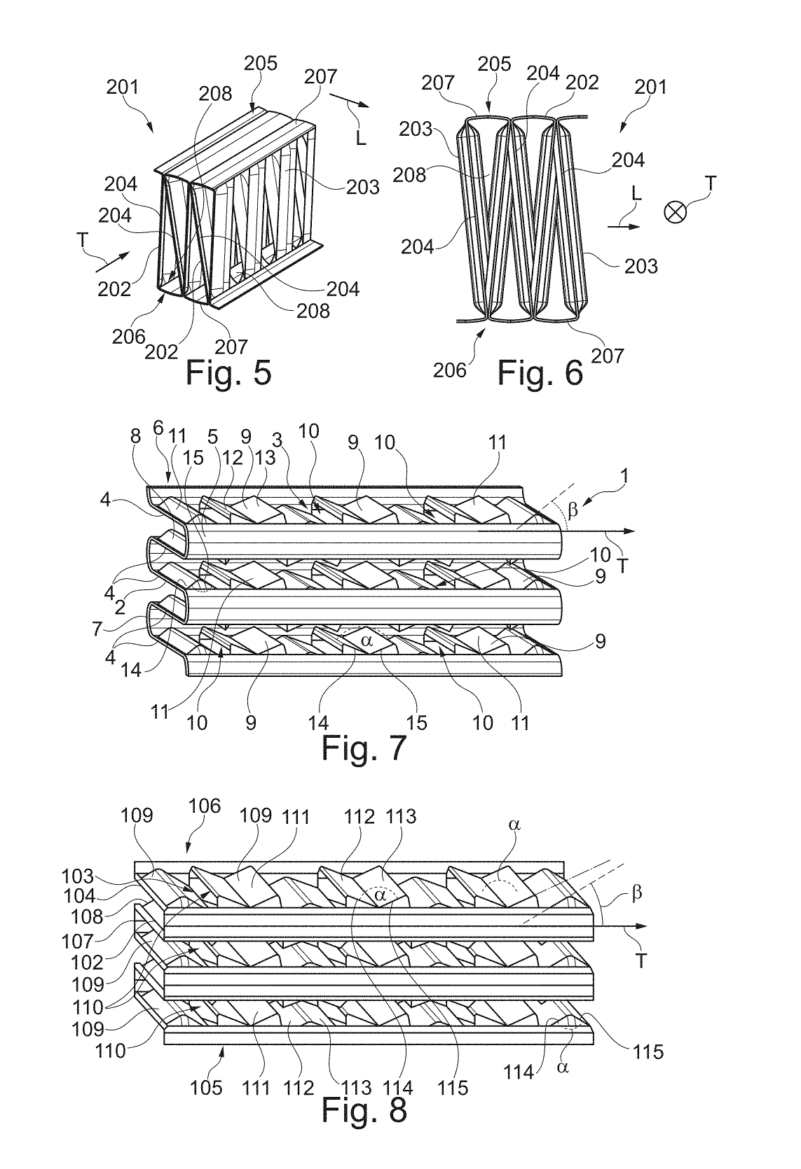

FIG. 5 shows a further exemplary embodiment of fin element 201 of the invention for a heat exchanger, which is not shown in greater detail. In this regard, FIG. 5 shows a representative detail of fin element 201, which can extend in any length in longitudinal direction L, depending on the particular requirements.

The heat exchanger can be, for example, a heating element for a motor vehicle. Fin elements 201 in this case are disposed between the heat transfer elements, which are not shown in FIG. 5 and which may be, for example, electrical heating elements or also tubes through which a heated coolant flows. Together with these heat transfer elements, a plurality of fin elements 201 form a heat exchanger block, which is normally used for heating an airflow. In this case, the airflow flows through the heat exchanger block in a depth direction T, which runs in the direction of a depth of the heat exchanger perpendicular to longitudinal direction L. The heat transfer elements, whose heat transfer surfaces are increased by means of fin elements 201, heat the airflow. This can then be used in particular for the energy-efficient heating of a vehicle cabin.

Fin element 201 in the exemplary embodiment shown in FIG. 5 is made as a corrugated fin with fins 202 and gills 203 of a continuous sheet corrugated in longitudinal direction L. Fins 202 and gills 203 in this case are made as one piece by a stamping, rolling, and/or folding method. In this case, fins 202 of fin element 201 have longitudinal sections 204 on which gills 203 are disposed. Longitudinal sections 204 of fins 202 can have in each case a plurality of gills 203. Alternatively, some of longitudinal sections 204 can also have no gills 203.

Fins 202 are arranged in rows in longitudinal direction L of fin element 201. In this case, fin element 201 has a first long side 205 and a second long side 206, opposite to first long side 205. Longitudinal sections 204 of fins 202 run disposed obliquely from first long side 205 to second long side 206 or from second long side 206 to first long side 205. In this case, each two longitudinal sections 204 form the two legs of a V shape. In the area of long sides 205, 206, fins 202 of fin element 201 have connecting sections 207, which form connecting surfaces for connecting fin element 201 to the heat transfer elements. Heat can be transferred via the connecting surfaces, formed by connecting sections 207, from heat transfer elements to longitudinal sections 204 of fins 202 of fin element 201 and from these to the airflow.

Between their longitudinal sections 204 and their connecting sections 207, fins 202 form flow chambers 208 through which the airflow flows, in particular in depth direction T. Moreover, partial airflows of the airflow flow through gills 203 out of flow chambers 208 into the particular adjacent flow chambers 208. The result is that, apart from the flow through flow chambers 208 in depth direction T, there is also a flow by the partial airflows through flow chambers 208, said flow being substantially transverse to depth direction T. Flow chambers 208 in the exemplary embodiment shown in FIG. 5 are also bounded by connecting sections 207, apart from longitudinal sections 204. In this regard, flow chambers 208, cut along longitudinal direction L of fin element 201, have a longitudinally extended V-shaped cross-sectional profile.

FIG. 6 shows a sectional view of fin element 5 shown in FIG. 201, whereby the cut is made in longitudinal direction L of fin element 201. Fin element 201 in longitudinal direction L of fin element 201 has fins 202 arranged in rows, whereby an airflow can flow through these from longitudinal sections 204 and connecting sections 207 of fins 202 of fin element 201 in depth direction T, disposed perpendicular to longitudinal direction L of fin element 201.

Fin element 201 has a first long side 205 and a second long side 206 opposite to first long side 205. Longitudinal sections 204 of fins 202 of fin element 201 are arranged running obliquely from first long side 205 to second long side 206 or from second long side 206 to first long side 205. Connecting sections 207 each connect two adjacent longitudinal sections 204 and are each disposed in the area of first long side 205 or second long side 206. Connecting sections 207 can be connected frictionally, positively locking, and/or materially to the heat transfer elements. Preferably gluing or soldering methods are used for this purpose. In the exemplary embodiment shown in FIG. 6, connecting sections 207 are arranged angled to longitudinal sections 204.

Longitudinal sections 204 of fins 202 have gills 203 which are arranged in rows along longitudinal sections 204. Exemplary embodiments of gills 203 will be described in greater detail in FIGS. 7 to 9.

FIG. 7 shows a detail of a fin element 1 formed according to FIGS. 1 and 2. Gills 3 are formed at longitudinal sections 4 of fins 2, said sections being arranged running between the two long sides 5, 6 of fin element 1. Longitudinal sections 4 each form a first plane whereby webs 9 flare out from said plane. A slot 10, which is formed by an opening in the material forming longitudinal sections 4 of fins 2, is disposed in each case between two webs 9. Webs 9 and slots 10 together form gills 3.

Webs 9 have web surfaces 11 flaring out from longitudinal sections 4. Web surfaces 11 each have two surface sections 12, 13, a first surface section 12 and a second surface section 13. The two surface sections 12, 13 are arranged angled to one another. Here, the two surface sections 12, 13 each form a leg 14, 15 of an angle α. In this regard, the angle α in the exemplary embodiment shown in FIG. 7 is about 160° in size. In alternative exemplary embodiments, the angle α can also be greater or smaller.

Surface sections 12, 13 in each case intersect depth direction T, in which an airflow to be heated flows through flow chambers 8, formed by longitudinal sections 4 and connecting sections 7 of fins 2 of fin element 1, at an angle β. The angle β in the exemplary embodiments shown in FIGS. 7 to 9 is smaller than 90°.

FIG. 8 shows a detail of a fin element 101 formed according to FIGS. 3 and 4. Gills 103 are formed at longitudinal sections 104 of fins 102 of fin element 101, said sections being arranged running between the two long sides 105, 106 of fin element 101. Webs 109 are flared out from longitudinal sections 104. A slot 110, which is formed by an opening in the material forming longitudinal sections 104 of fins 102 of fin element 101, is disposed in each case between two webs 109. Webs 109 and slots 110 together form gills 103.

Webs 109 have web surfaces 111 flaring out from longitudinal sections 104. Web surfaces 111 each have two surface sections 112, 113, a first surface section 112 and a second surface section 113. The two surface sections 112, 113 are arranged angled to one another. Here, the two surface sections 112, 113 each form a leg 114, 115 of an angle α. In this regard, the angle α in the exemplary embodiment shown in FIG. 8 is about 160° in size. In alternative exemplary embodiments, the angle α can also be greater or smaller.

Surface sections 112, 113 intersect depth direction T, in which an airflow to be heated flows through flow chambers 108, formed by longitudinal sections 104 and connecting sections 107 of fins 102 of fin element 101, at an angle β. The angle β in the exemplary embodiments shown in FIGS. 7 to 9 is smaller than 90°.

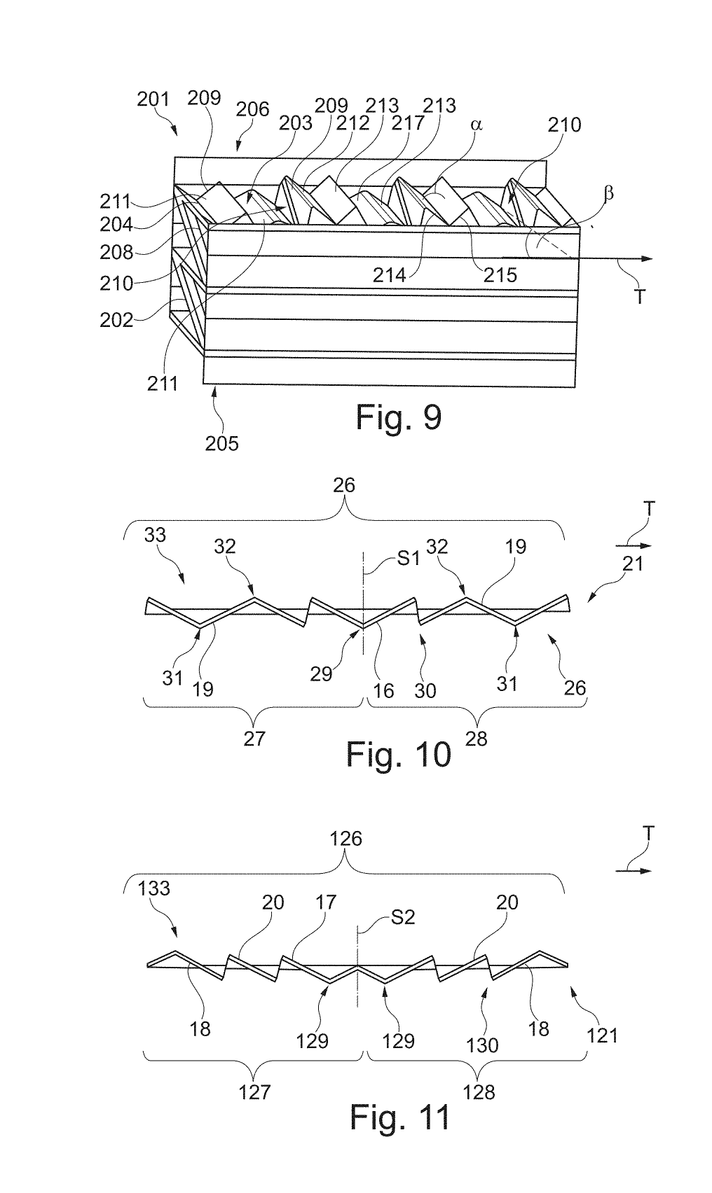

FIG. 9 shows a detail of a fin element 201 formed according to FIGS. 5 and 6. Gills 203 are formed at longitudinal sections 204 of fins 202, said sections being arranged running between the two long sides 205, 206 of fin element 201. Webs 209 are flared out from longitudinal sections 204. A slot 210, which is formed by an opening in the material forming longitudinal sections 204 of fins 202 of fin element 101, is disposed in each case between two webs 209. Webs 209 and slots 210 together form gills 203.

Webs 209 have web surfaces 211 flaring out from longitudinal sections 204. Web surfaces 211 each have two surface sections 212, 213, a first surface section 212 and a second surface section 213. The two surface sections 212, 213 are arranged angled to one another. Here, the two surface sections 212, 213 each form a leg 214, 215 of an angle α. The angle α in the exemplary embodiment shown in FIG. 9 is about 110° in size. In alternative exemplary embodiments, the angle α can also be greater or smaller.

Surface sections 212, 213 intersect depth direction T, in which an airflow to be heated flows through flow chambers 208, formed by longitudinal sections 204 and connecting sections 207 of fins 202 of fin element 101, at an angle β. The angle β in the exemplary embodiments shown in FIGS. 7 to 9 is smaller than 90°.

FIGS. 10 to 19 show exemplary embodiments of gills with alternative cross-sectional shapes of the webs shown in FIGS. 7 to 9. The direction of the cut corresponds hereby to the depth direction T shown in FIGS. 7 to 9. In this case, the webs each have by way of example a substantially V-shaped cross-sectional profile 16, a substantially W-shaped cross-sectional profile 17, a substantially hook-shaped cross-sectional profile 18, a substantially Z-shaped cross-sectional profile 19, or a substantially I-shaped cross-sectional profile 20. Moreover, the webs can also have web sections with substantially V-shaped, substantially W-shaped, substantially hook-shaped, substantially Z-shaped, and/or substantially I-shaped cross-sectional profiles.

In this case, in the exemplary embodiments shown in FIGS. 10 to 19, a number of webs formed adjacent to one another on a longitudinal section of a fin of a fin element of the invention form a group. The particular group 22 has a specific arrangement pattern of a series of webs, each with a substantially V-shaped cross-sectional profile 16, a substantially W-shaped cross-sectional profile 17, a substantially hook-shaped cross-sectional profile 18, a substantially Z-shaped cross-sectional profile 19, and/or a substantially I-shaped cross-sectional profile 20.

A group in this case can extend over the entire length of the long side of a fin of a fin element of the invention. Alternatively, a plurality of identical and/or different groups can also be arranged along a long side of a fin of the fin element.

The groups specifically formed in this way can repeat periodically along a longitudinal section. Moreover, a plurality of differently formed groups can be arranged along a longitudinal section.

FIG. 10 shows a first exemplary embodiment of a group 26 of webs arranged on a longitudinal section 21 of a fin of a fin element of the invention. Group 26 has a mirror axis 51, which divides group 26 into two sections 27, 28, formed mirror-symmetric to one another and adjacent to one another at mirror axis 51. A web with a substantially V-shaped cross-sectional profile 16 is disposed at mirror axis 51. The two legs of the V-shaped cross-sectional profile form an angle whose vertex is located on mirror axis S1. Peak 29 of V-shaped cross-sectional profile 16 in this case is flared out from a first side 30 of longitudinal section 21.

The two sections 27, 28 each have a web with a substantially Z-shaped cross-sectional profile 19, each with a first peak 31 and a second peak 32. First peaks 31 are each flared out from first side 30 of longitudinal section 21. Second peaks 32 are each flared out from a second side 33, opposite to first side 30, of longitudinal section 21.

FIG. 11 shows a further exemplary embodiment of a group 126 of webs arranged on a longitudinal section 121 of a fin of a fin element of the invention. Group 126 has a mirror axis S2, which divides group 126 into two sections 127, 128, formed mirror-symmetric to one another and adjacent to one another at mirror axis S2. A web with a substantially W-shaped cross-sectional profile 17 is disposed at mirror axis S2. The two hook-shaped sides of the W-shaped cross-sectional profile 17 form an angle whose vertex is located on mirror axis S2. Peaks 129 of the two hook-shaped sides of the W-shaped cross-sectional profile 17 are flared out from a first side 130 of longitudinal section 121.

The two sections 127, 128 each have a web with an I-shaped cross-sectional profile 20 and a web with a substantially hook-shaped cross-sectional profile 18, each of which are made flared out in sections from first side 130 of longitudinal section 121 and from a second side 133, opposite to first side 130, of longitudinal section 121.

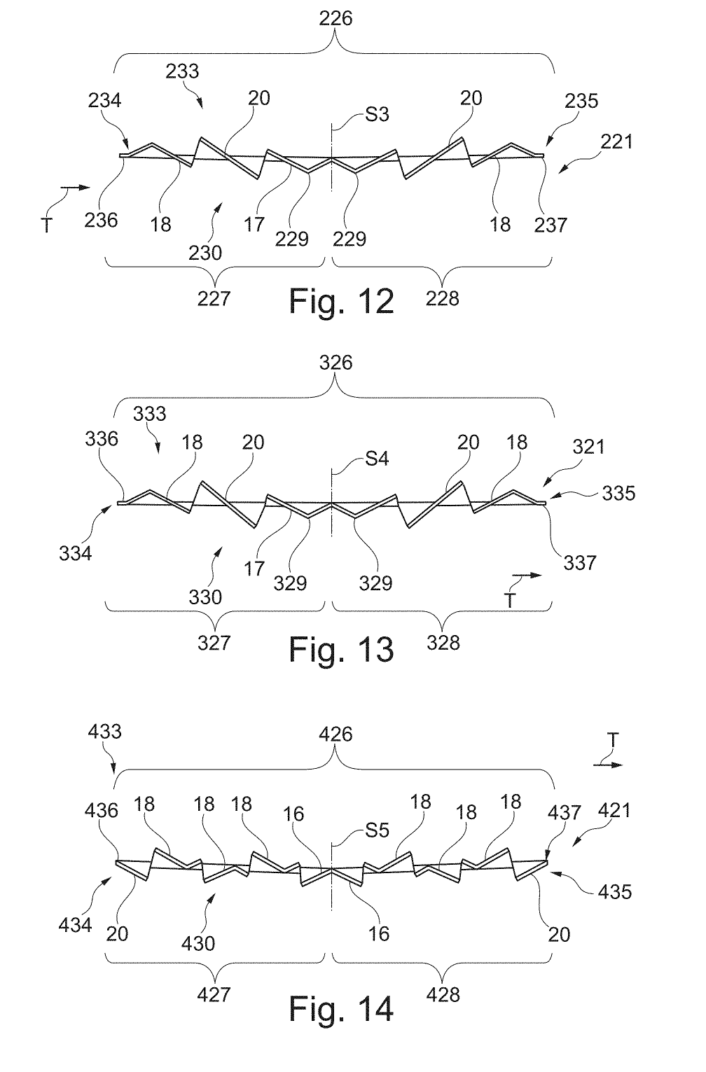

FIG. 12 shows a further exemplary embodiment of a group 226 of webs arranged on a longitudinal section 221 of a fin of a fin element of the invention. Group 226 has a mirror axis S3, which divides group 226 into two sections 227, 228, formed mirror-symmetric to one another and adjacent to one another at mirror axis S3.

A web with a substantially W-shaped cross-sectional profile 17 is disposed at mirror axis S3. The two hook-shaped sides of the W-shaped cross-sectional profile 17 form an angle whose vertex is located on mirror axis S3. Peaks 229 of the two hook-shaped sides of the W-shaped cross-sectional profile 17 are flared out from a first side 230 of longitudinal section 221.

The two sections 227, 228 each have a web with an I-shaped cross-sectional profile 20 and a web with a substantially hook-shaped cross-sectional profile 18, each of which are made flared out in sections from first side 230 of longitudinal section 221 and from a second side 233, opposite to first side 230, of longitudinal section 121.

Group 226 has a first outer edge 234 and a second outer edge 235. The webs with the substantially hook-shaped cross-sectional profile 18 are each disposed at one of the two outer edges 234, 235 of group 226. The web, disposed at first outer edge 234, with a substantially hook-shaped cross-sectional profile 18 has a web end 236, facing first outer edge 234 and placed substantially parallel to depth direction T. The web, disposed at second outer edge 235, with a substantially hook-shaped cross-sectional profile 18 has a web end 237, facing second outer edge 235 and placed substantially parallel to depth direction T.

Apart from this feature, the exemplary embodiments shown in FIGS. 11 and 12 differ with respect to the size of the angle with which the webs with an I-shaped cross-sectional profile 20 intersect depth direction T.

FIG. 13 shows a further exemplary embodiment of a group 326 of webs arranged on a longitudinal section 321 of a fin of a fin element of the invention. Group 326 has a mirror axis S4, which divides group 326 into two sections 327, 328, formed mirror-symmetric to one another and adjacent to one another at mirror axis S4.

A web with a substantially W-shaped cross-sectional profile 17 is disposed at mirror axis S4. The two hook-shaped sides of the W-shaped cross-sectional profile 17 form an angle whose vertex is located on mirror axis S4. Peaks 329 of the two hook-shaped sides of the W-shaped cross-sectional profile 17 are flared out from a first side 330 of longitudinal section 321.

The two sections 327, 328 each have a web with an I-shaped cross-sectional profile 20 and a web with a substantially hook-shaped cross-sectional profile 18, each of which are made flared out in sections from first side 330 of longitudinal section 121 and from a second side 333, opposite to first side 330, of longitudinal section 321.

Group 326 has a first outer edge 334 and a second outer edge 335. The webs with the substantially hook-shaped cross-sectional profile 18 are each disposed at one of the two outer edges 334, 335 of group 326. The web, disposed at first outer edge 334, with a substantially hook-shaped cross-sectional profile 18 has a web end 336, facing first outer edge 334 and placed substantially parallel to depth direction T. The web, disposed at second outer edge 335, with a substantially hook-shaped cross-sectional profile 18 has a web end 337, facing second outer edge 335 and placed substantially parallel to depth direction T.

The exemplary embodiments shown in FIGS. 11, 12, and 13 differ in particular with respect to the size of the angle, with which the webs with an I-shaped cross-sectional profile 20 intersect depth direction T.

FIG. 14 shows a further exemplary embodiment of a group 426 of webs arranged on a longitudinal section 421 of a fin of a fin element of the invention. Group 426 has a mirror axis S5, which divides group 426 into two sections 427, 428, formed mirror-symmetric to one another and adjacent to one another at mirror axis S5.

A web with a substantially V-shaped cross-sectional profile 16 is disposed at mirror axis S5. The two legs of the V-shaped cross-sectional profile 16 form an angle whose vertex is located on mirror axis S5. In this case, both legs of the V-shaped cross-sectional profile 16 are flared out from a first side 430 of longitudinal section 421.

The two sections 427, 428 each have three webs with a substantially hook-shaped cross-sectional profile 18. The webs with the hook-shaped cross-sectional profile 18 are each flared alternately out from first side 430 of longitudinal section 421 or from a second side 433, opposite to first side 430, of longitudinal section 421.

Group 426, moreover, has a first outer edge 434 and a second outer edge 435. A web with a substantially I-shaped cross-sectional profile 20 is disposed at outer edges 434, 435.

The web, disposed at first outer edge 434, with a substantially I-shaped cross-sectional profile 20 has a web end 436, facing first outer edge 434 and placed substantially parallel to depth direction T. The web, disposed at second outer edge 435, with a substantially I-shaped cross-sectional profile 20 has a web end 437, facing second outer edge 435 and placed substantially parallel to depth direction T.

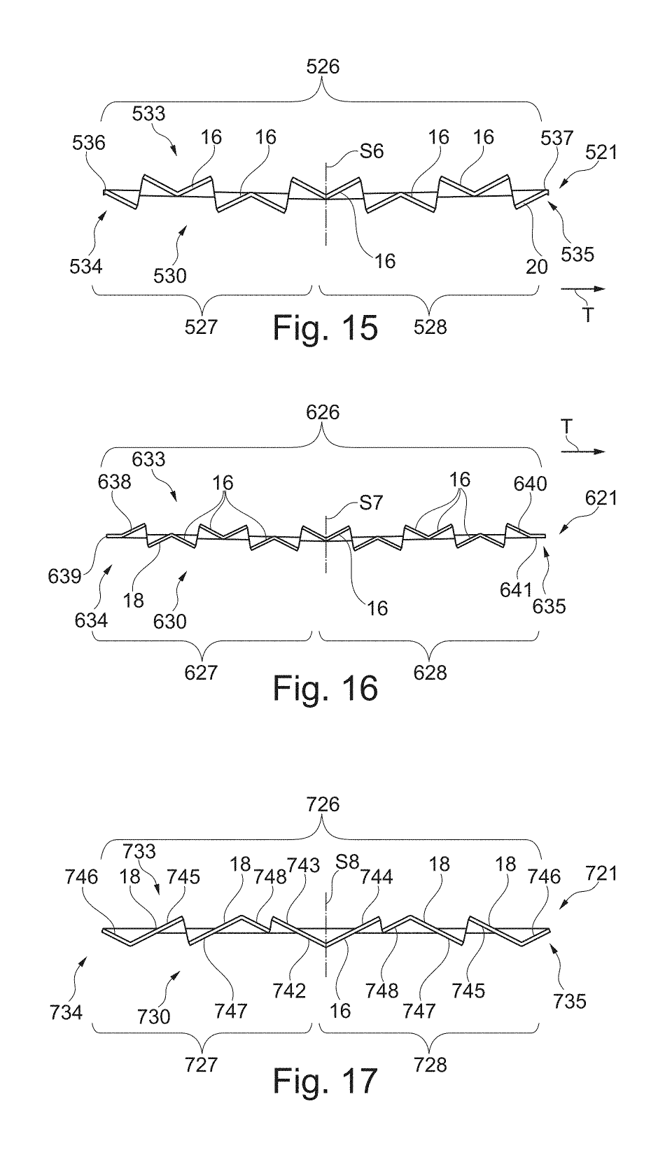

FIG. 15 shows a further exemplary embodiment of a group 526 of webs arranged on a longitudinal section 521 of a fin of a fin element of the invention. Longitudinal section 521 has a first side 530 and a second side 533 opposite to first side 530. Group 526 has a mirror axis S6, which divides group 526 into two sections 527, 528, formed mirror-symmetric to one another and adjacent to one another at mirror axis S6.

A web with a substantially V-shaped cross-sectional profile 16 is disposed at mirror axis S6. The two legs of the V-shaped cross-sectional profile 16 form an angle whose vertex is located on mirror axis S6. In this case, both legs of the V-shaped cross-sectional profile 16 are flared out from a second side 533 of longitudinal section 521.

The two sections 527, 528 each have two further webs with a substantially V-shaped cross-sectional profile 16. The webs with the substantially V-shaped cross-sectional profile 16 are each flared out alternately from first side 530 of longitudinal section 521 or from second side 533 of longitudinal section 521.

Group 526, moreover, has a first outer edge 534 and a second outer edge 535. A web with a substantially I-shaped cross-sectional profile 20 is disposed at outer edges 534, 535.

The web, disposed at first outer edge 534, with a substantially I-shaped cross-sectional profile 20 has a web end 536, facing first outer edge 534 and placed substantially parallel to depth direction T. The web, disposed at second outer edge 535, with a substantially I-shaped cross-sectional profile 20 has a web end 537, facing second outer edge 535 and placed substantially parallel to depth direction T.

FIG. 16 shows a further exemplary embodiment of a group 626 of webs arranged on a longitudinal section 621 of a fin of a fin element of the invention. Longitudinal section 621 has a first side 630 and a second side 633 opposite to first side 630. Group 626 has a mirror axis S7, which divides group 626 into two sections 627, 628, formed mirror-symmetric to one another and adjacent to one another at mirror axis S7.

A web with a substantially V-shaped cross-sectional profile 16 is disposed at mirror axis S7. The two legs of the V-shaped cross-sectional profile 16 form an angle whose vertex is located on mirror axis S7. In this case, both legs of the V-shaped cross-sectional profile 16 are flared out from a second side 633 of longitudinal section 621.

The two sections 627, 628 each have three further webs with a substantially V-shaped cross-sectional profile 16. The webs with the substantially V-shaped cross-sectional profile 16 are each flared out alternately from first side 630 of longitudinal section 621 or from second side 633 of longitudinal section 621.

Group 626, moreover, has a first outer edge 634 and a second outer edge 635. A web with a substantially hook-shaped cross-sectional profile 18 is disposed at outer edges 634, 635. In this case, the two webs with a substantially hook-shaped cross-sectional profile 18 are flared out from second side 633 of longitudinal section 621.

The web, disposed on first outer edge 634, with a substantially hook-shaped cross-sectional profile 18 has a first leg 638, facing mirror axis S7, and a second leg 639, facing first outer edge 634, whereby second leg 639 is placed substantially parallel to depth direction T.

The web disposed in the area of second outer edge 635 and with a substantially hook-shaped cross-sectional profile 18 has a first leg 640, facing mirror axis S7, and a second leg 641, facing second outer edge 635, whereby second leg 641 is placed substantially parallel to depth direction T.

FIG. 17 shows a further exemplary embodiment of a group 726 of webs arranged on a longitudinal section 721 of a fin of a fin element of the invention. Longitudinal section 721 has a first side 730 and a second side 733 opposite to first side 730. Group 726 has a mirror axis S8, which divides group 726 into two sections 727, 728, formed mirror-symmetric to one another and adjacent to one another at mirror axis S8.

A web with a substantially V-shaped cross-sectional profile 16 is disposed at mirror axis S8. The two legs of the V-shaped cross-sectional profile 16 form an angle whose vertex is located on mirror axis S8. In this case, a first section 742 of the V-shaped cross-sectional profile 16 is flared out from first side 730 of longitudinal section 721. A second section 743 and a third second 744 of the substantially V-shaped cross-sectional profile 16 are adjacent to opposite ends of first section 742 of the V-shaped cross-sectional profile 16. Second section 743 and third section 744 of the substantially V-shaped cross-sectional profile 16 are flared out from second side 733 of longitudinal section 721.

Group 726, moreover, has a first outer edge 734 and a second outer edge 735. An edge-side web with a substantially hook-shaped cross-sectional profile 18 is disposed in the areas of both outer edges 734, 735. The edge-side webs with the substantially hook-shaped cross-sectional profile 18 each have a first leg 745 and a second leg 746, whereby first leg 745 is about double the length of second leg 746. First legs 745 have a first section, which is disposed substantially facing mirror axis S8 and which is flared out from second side 733 of longitudinal section 721, and a second section, which is disposed substantially facing away from mirror axis S8 and which is flared out from first side 730 of longitudinal section 721.

A further web with a substantially hook-shaped cross-sectional profile 18 is disposed in each case in the two sections 727, 728 between the edge-side webs with the substantially hook-shaped cross-sectional profile 18 and the web disposed in the area of mirror axis S8 and having a substantially V-shaped cross-sectional profile 16. The two further webs with a substantially hook-shaped cross-sectional profile 18 each have a first leg 747 and a second leg 748, whereby first leg 747 is about double the length of second leg 748. First legs 747 have a first section, which is disposed substantially facing mirror axis S8 and which is flared out from second side 733 of longitudinal section 721, and a second section, which is disposed substantially facing away from mirror axis S8 and which is flared out from first side 730 of longitudinal section 721.

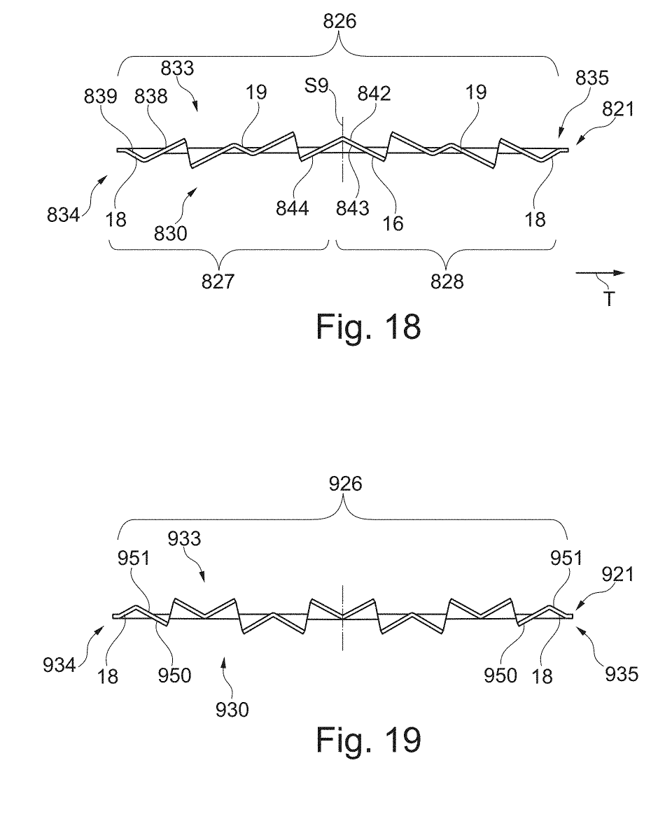

FIG. 18 shows a further exemplary embodiment of a group 826 of webs arranged on a longitudinal section 821 of a fin of a fin element of the invention. Longitudinal section 821 has a first side 830 and a second side 833 opposite to first side 830. Group 826 has a mirror axis S9, which divides group 826 into two sections 827, 828, formed mirror-symmetric to one another and adjacent to one another at mirror axis S9.

A web with a substantially V-shaped cross-sectional profile 16 is disposed at mirror axis S9. The two legs of the V-shaped cross-sectional profile 16 form an angle whose vertex is located on mirror axis S9. In this case, a first section 842 of the V-shaped cross-sectional profile 16 is flared out from second side 833 of longitudinal section 821. A second section 843 and a third second 844 of the substantially V-shaped cross-sectional profile 16 are adjacent to opposite ends of first section 842 of the V-shaped cross-sectional profile 16. Second section 843 and third section 844 of the substantially V-shaped cross-sectional profile 16 are flared out from first side 830 of longitudinal section 821.

A web with a substantially Z-shaped cross-sectional profile 19 is disposed adjacent to sections 843, 844. The Z-shaped cross-sectional profile has two substantially hook-shaped subsections 838, 839, each of which are flared out in sections from first side 830 and from second side 833 of longitudinal section 821.

Group 826, moreover, has a first outer edge 834 and a second outer edge 835. A web with a substantially hook-shaped cross-sectional profile 18 is disposed at outer edges 834, 835. In this case, the two webs with a substantially hook-shaped cross-sectional profile 18 are flared out in sections from first side 830 and from second side 833 of longitudinal section 821.

The webs disposed in the area of one of outer edges 834, 835 and having a substantially hook-shaped cross-sectional profile 18 each have an end section facing outer edges 834, 835, said section being disposed substantially parallel to depth direction T.

FIG. 19 shows a further exemplary embodiment of a group 926 of webs arranged on a longitudinal section 921 of a fin of a fin element of the invention. The exemplary embodiment shown in FIG. 19 corresponds substantially to the exemplary embodiment shown in FIG. 16. In the exemplary embodiment shown in FIG. 19, in contrast to the exemplary embodiment shown in FIG. 16, the two webs disposed in the area of outer edges 934, 935 and having a substantially hook-shaped cross-sectional profile 18 have a section 950, flared out from first side 930 of longitudinal section 921, and a section, 951 flared out from second side 933 of longitudinal section 921.

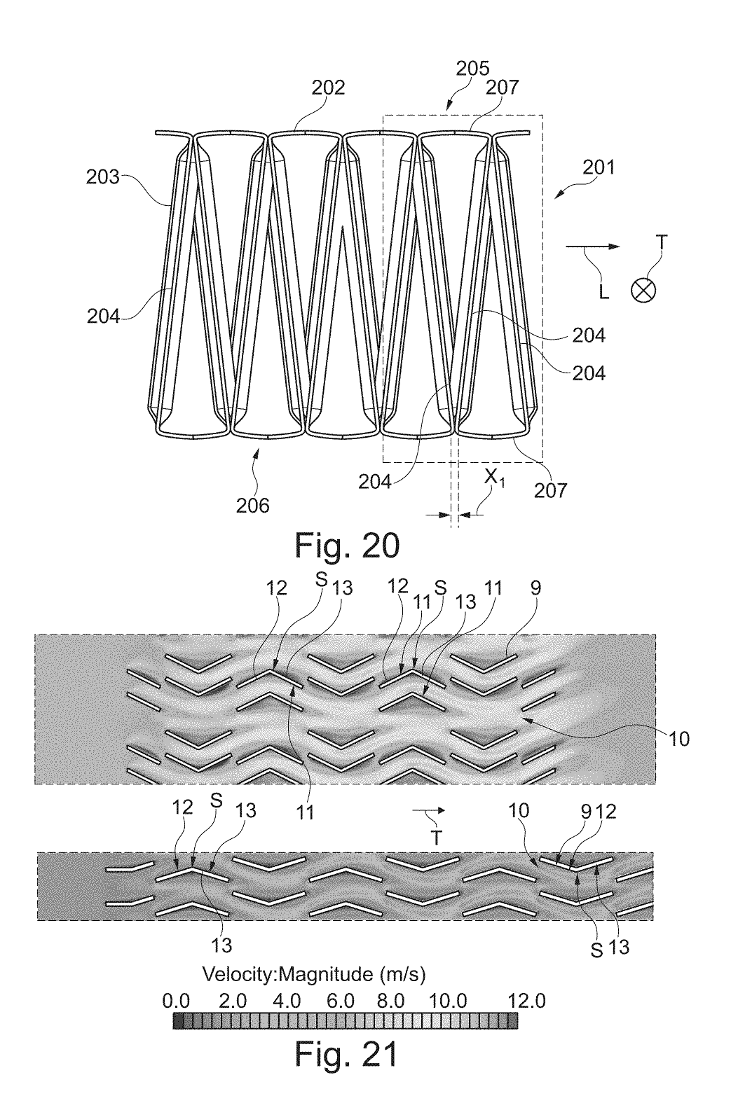

FIG. 20 shows an enlargement of the detail, shown in FIG. 6, of a fin element 201 according to FIG. 5. The cut is made here also in longitudinal direction L of fin element 201. Fin element 201 in longitudinal direction L of fin element 201 has fins 202 which are arranged in rows and through which an airflow can flow in depth direction T perpendicular to longitudinal direction L of fin element 201.

Fin element 201 has a first long side 205 and a second long side 206 opposite to first long side 205. Longitudinal sections 204 of fins 202 are arranged running obliquely from first long side 205 to second long side 206 or from second long side 206 to first long side 205. Connecting sections 207 each connect two adjacent longitudinal sections 204 and are each disposed in the area of first long side 205 or second long side 206. Connecting sections 207 can be connected frictionally, positively locking, and/or materially to the heat transfer elements. Preferably gluing or soldering methods are used for this purpose. In the exemplary embodiment shown in FIG. 20, connecting sections 207 are arranged angled to longitudinal sections 204. Longitudinal sections 204 of fins 202 have gills 203 which are arranged in rows along longitudinal sections 204.

Longitudinal sections 204 of two adjacent fins 202, said sections being disposed facing one another, are each connected together in the area of first long side 205 or second long side 206 of fin element 201. This reduces the length of the fin distance X₁ between the two longitudinal sections 204, facing one another, toward first long side 205 or toward second long side 206 of fin element 201. In the area of connecting sections 207 of adjacent fins 202, adjacent fins 202 are in contact and fin distance X₁ approaches 0.

FIG. 21 shows a view, cut along the depth direction, of webs 9 and slots 10 of a fin element formed according to FIGS. 1, 2, and 7. An air velocity profile of the air flowing along web surfaces 11 or surface sections 12, 13 is placed above the sectional view. The velocity profile shows that the air when flowing along web surfaces 11 or surface sections 12, 13 changes its direction and its velocity at the vertices S due to the angled arrangement of the surface sections. This leads overall to a homogenization of the air velocity profile and also the air temperature profile. The result is a high heat transfer performance, combined with a low pressure loss on the part of the airflow flowing through the fin element.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A fin element for a heat exchanger for a heating, ventilation, and/or air conditioning system of a motor vehicle, the fin element comprising:
at least two connecting sections;
at least two longitudinal sections, two adjacent longitudinal sections being connected to one another by a connecting section; and
gills formed by webs and slots, at least one of the longitudinal sections having a gill,
wherein at least one of the webs has a flared web surface,
wherein the web surface is flared out from the at least one longitudinal section, and
wherein the web surface forms at least two surface sections arranged angled to one another.

2. The fin element for a heat exchanger according to claim 1, wherein a plurality of the webs or each web has a web surface that is flared out from the at least one longitudinal section and forms at least two surface sections arranged angled to one another.

3. The fin element for a heat exchanger according to claim 1, wherein a plurality or all of the longitudinal sections have flared web surfaces with at least two surface sections arranged angled to one another.

4. The fin element for a heat exchanger according to claim 1, wherein flow chambers are formed between the connecting sections and the longitudinal sections, said chambers which can be flown through in a depth direction T, in particular with air, whereby the surface sections, formed by the particular web surfaces intersect the depth direction T at an angle β.

5. The fin element for a heat exchanger according to claim 1, wherein the webs have a V-shaped, W-shaped, Z-shaped, hook-shaped, and/or I-shaped cross-section profile and/or web sections with a V-shaped, W-shaped, Z-shaped, hook-shaped, and/or I-shaped cross-sectional profile, whereby the webs with a V-shaped, W-shaped, Z-shaped, L-shaped, I-shaped, and/or hook-shaped cross-sectional profile and/or the web sections with a V-shaped, W-shaped, Z-shaped, L-shaped, I-shaped, and/or hook-shaped cross-sectional profile are flared out from a first side of the at least one longitudinal section and/or from a second side, opposite to the first side of the at least one longitudinal section.

6. The fin element for a heat exchanger according to claim 5, wherein a number of webs, arranged adjacent to one another, form at least one group, whereby the at least one group has an arrangement pattern, specific for the at least one group, comprising a series of webs each with a V-shaped, W-shaped, Z-shaped, hook-shaped, and/or I-shaped cross-sectional profile and/or web sections each with a V-shaped, W-shaped, Z-shaped, I-shaped, and/or hook-shaped cross-sectional profile.

7. The fin element for a heat exchanger according to claim 6, wherein the at least one longitudinal section has a plurality of groups, each of which has an arrangement pattern, specific for the particular group, comprising a series of webs each with a V-shaped, W-shaped, Z-shaped, hook-shaped, and/or I-shaped cross-sectional profile and/or web sections each with a V-shaped, W-shaped, Z-shaped, hook-shaped, and/or I-shaped cross-sectional profile.

8. The fin element for a heat exchanger according to claim 6, wherein the at least one longitudinal section has at least one group that repeats periodically along the at least one longitudinal section.

9. The fin element for a heat exchanger according to claim 6, wherein the at least one group has at least one mirror axis, which divides the group into two sections formed mirror-symmetric to one and adjacent to one another.

10. The fin element for a heat exchanger according to claim 1, wherein the longitudinal sections and the connecting sections form a U-shaped, V-shaped, rectangular, trapezoidal, and/or Ω-shaped cross-sectional profile.

11. The fin element for a heat exchanger according to claim 1, wherein the connecting sections are connected materially, frictionally, and/or positively locking to heat exchange surfaces of the heat exchanger.

12. A heat exchanger, in particular for a heating, ventilation, and/or air conditioning system of a motor vehicle, wherein the heat exchanger has at least one fin element for a heat exchanger according to claim 1.

13. The heat exchanger according to claim 12, wherein the heat exchanger has at least two heat transfer elements, wherein the fin element is disposed between the two heat transfer elements.

14. The heat exchanger according to claim 12, wherein the heat exchanger is an electrical heating device.

15. The heat exchanger according to claim 14, wherein the electrical heating device has PTC heating elements, whereby the fin elements and the PTC heating elements are arranged adjacent to one another.
